(19) United States
(12) Patent Application Publication
(10) Pub. No.: US 2008/0317031 A1
(43) Pub. Date: Dec. 25, 2008

(54) COMMUNICATION APPARATUS AND DATA PROCESSING METHOD

(75) Inventor: Go Inoue, Fujisawa-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/140,984

(22) Filed: Jun. 17, 2008

(30) Foreign Application Priority Data
Jun. 19, 2007 (JP) 2007-161430

(51) Int. Cl. H04L 12/56

(52) U.S. Cl. 370/392

(57) ABSTRACT

A communication apparatus which receives data including a destination address from an external apparatus, changes the destination address included in the received data to an address of the communication apparatus, and sends the data whose destination address was changed to an address of the communication apparatus.

### BACKGROUND OF THE INVENTION

1. Field of the Invention

The present invention relates to a communication apparatus which receives data from an external apparatus.

2. Description of the Related Art

Conventionally, the cause of a communication fault can be ascertained using software to acquire packet data flowing in a network. Thus, the packet data, when the fault occurred, can be obtained and analyzed.

Further, the cause of the fault can be ascertained by reproducing the occurrence of the fault by resending the acquired packet data through the network and analyzing the reproduced fault.

For example, Japanese Patent Application Laid-Open No. 8-116334 discuses an apparatus which monitors and collects packet data on a network. In the technique discussed in Japanese Patent Application Laid-Open No. 8-116334, the collected packet data is stored in a storage device, and that packet data is sent over the network to reproduce a fault.

However, in a method which resends acquired packet data over a network to reproduce the sending of the packet data, unnecessary packet data is flowed through the network, so that there is the possibility of superfluous network traffic being generated. Further, there is the drawback that it takes time and effort to reproduce the sending of the packet data, such as having to decide when to resend the data without any adverse impact even if the occurrence of a fault is reproduced.

On the other hand, rather than reproducing the sending of packet data under the original network environment, a method can also be considered of separately constructing a pseudo-network environment, and sending the packet data over the separate network environment. According to this method, the possibility of superfluous network traffic being generated under the original network environment is eliminated. However, since the pseudo-network environment is different from the original network environment, there is the possibility that the occurrence of the fault is not reproduced or the substance of the reproduced fault is different. If the cause of the fault is an apparatus present in the original network environment, there is the possibility that the occurrence of the fault is not reproduced under a pseudo-network environment using a substitute for that apparatus. Further, separately constructing such a pseudo-network environment creates a large amount of work.

### SUMMARY OF THE INVENTION

The present invention is directed to a communication apparatus, a data processing method, and a program, which can reproduce the sending of packet data while suppressing unnecessary network traffic.

According to an aspect of the present invention, a communication apparatus includes a receiving unit configured to receive data including a destination address from an external apparatus, a change unit configured to change the destination address to an address of the communication apparatus, and a sending unit configured to send the data whose destination address was changed by the change unit to an address of the communication apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated herein and constitute a part of the specification, illustrate exemplary embodiments, features, and aspects of the invention and, together with the description, serve to explain the principles of the invention.

FIG. 1 is a diagram illustrating the hardware configuration of the communication apparatus according to an exemplary embodiment of the present invention.

FIG. 2 is a diagram illustrating the software configuration in the communication apparatus.

FIG. 3 is a diagram illustrating the software configuration of a packet analysis unit in more detail.

FIG. 4 is a diagram illustrating the network system according to an exemplary embodiment of the present invention.

FIG. 5 is a flowchart illustrating the processing performed by the packet analysis unit.

FIG. 6 is a diagram illustrating one example of a list of packet data stored in a storage device.

FIG. 7 is a diagram illustrating one example of a details screen which illustrates the details of a packet.

FIG. 8 is a flowchart illustrating the processing performed by the packet analysis unit.

FIG. 9 is a diagram illustrating part of the packet data after being changed.

FIG. 10 is a diagram illustrating one example of a settings screen for setting a filter condition.

FIG. 11 is a diagram illustrating the state when packet data edited by the processing of FIG. 8 is sent to reproduce a fault.

FIG. 12 is a diagram illustrating one example of the settings screen for setting a discard mode.

FIG. 13 is a flowchart illustrating the processing performed by the printing application unit.

FIG. 14 is a diagram illustrating part of the No. 2 packet data of FIG. 6.

FIG. 15 is a diagram illustrating the No. 2 packet data after being subjected to processing based on FIG. 8.

FIG. 16 is a diagram illustrating a conventional method of acquiring packet data.

FIG. 17 is a diagram illustrating a conventional method of reproducing a fault.

### DETAILED DESCRIPTION OF THE EMBODIMENTS

Various exemplary embodiments, features, and aspects of the invention will be described in detail below with reference to the drawings.

### First Exemplary Embodiment

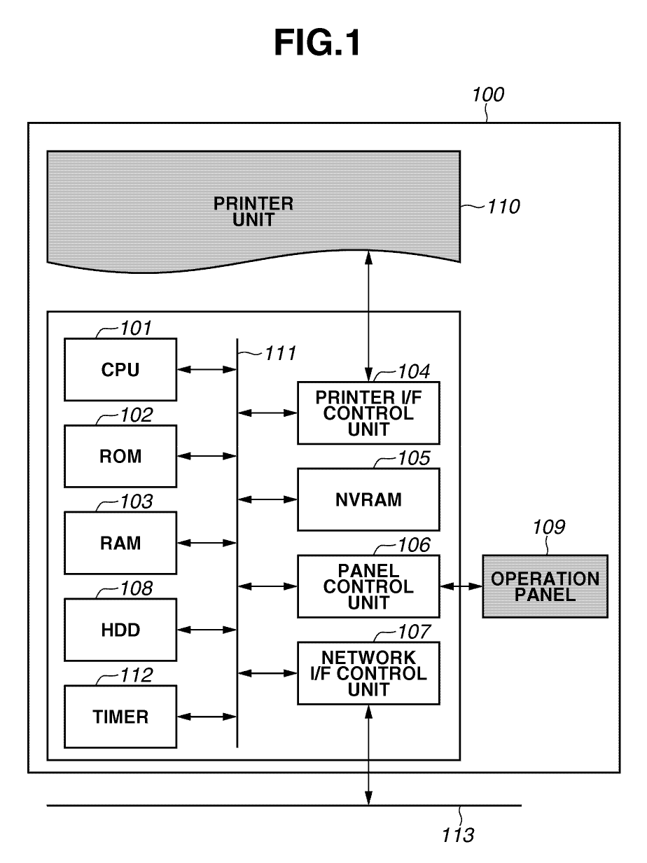

FIG. 1 is a diagram illustrating the hardware configuration of a communication apparatus 100 according to an exemplary embodiment of the present invention. A print apparatus will now be described as one example of the communication apparatus 100.

A central processing unit (CPU) 101 controls the whole apparatus by executing a software program which controls the communication apparatus 100. A read-only memory (ROM) 102 stores a boot program of the communication apparatus 100, various programs for controlling the communication apparatus 100, and fixed parameters. A random access memory (RAM) 103 stores the temporary data required for the CPU 101 to control the communication apparatus 100.

A printer interface (I/F) control unit 104 controls a printer unit 110 according to an order from the CPU 101. A non-volatile random access memory (NVRAM) 105 stores the values for various settings of the communication apparatus 100. A panel control unit 106 controls an operation panel 109 according to an order from the CPU 101, displays various pieces of information on the operation panel 109, and acquires instructions input by a user from the operation panel 109. A network I/F control unit 107 controls the sending/receiving of data by a local area network (LAN) 113 according to an order from the CPU 101.

A hard disk drive (HDD) 108 stores print data and various other kinds of data. The operation panel 109 has a display apparatus and a button, which are used to display various kinds of information and input instructions from a user. The printer unit 110 prints an image on a sheet based on print data. A timer 112 measures the elapsed time in the timer processing.

A bus 111 is connected to the CPU 101, the ROM 102, the RAM 103, the printer I/F control unit 104, the NVRAM 105, the panel control unit 106, the network I/F control unit 107, the HDD 108, and the timer 112. The bus 111 is a system bus for transferring control signals and data signals among these units.

The LAN 113 is a communication medium for data communication among a plurality of communication apparatuses. The LAN 113 may be wired or wireless.

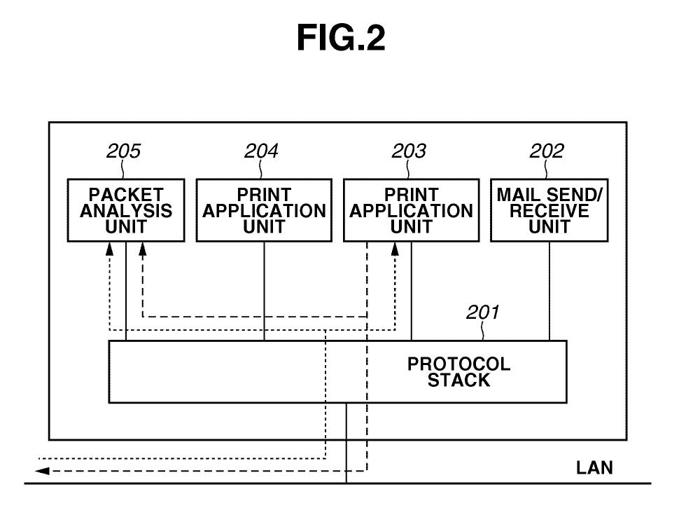

FIG. 2 is a diagram illustrating the software configuration in the communication apparatus 100. A protocol stack module (hereinafter, “protocol stack”) 201 controls the network layers when packet data is exchanged with an external apparatus via the LAN 113. The protocol stack 201 defines the exchanges performed between a TCP/IP transport and Ethernet™ hardware, and provides an interface relating to the network communication to an upper-level application layer.

Various network applications are present in the protocol stack 201 upper layer. A mail send/receive unit 202 sends/receives mail via the protocol stack 201. To send/receive mail, a protocol such as Post Office Protocol Version 3 (POP3) or Simple Mail Transfer Protocol (SMTP) is used. A print application unit 203 uses, for example, port number 9100 to receive a print request or print data via the protocol stack 201, and controls printing based on the print request or print data. A print application unit 204 uses, for example, port number 515 to receive a print request or print data via the protocol stack 201, and controls printing based on the print request or print data. The port numbers mentioned above are just examples. A user may change the number to any port numbers. A packet analysis unit 205 analyzes the packet data.

The packet analysis unit 205 is located in the application layer. However, packet data can be hooked and acquired inside the protocol stack 201 by using a promiscuous mode at the socket interface with respect to the protocol stack 201. Namely, in parallel with the print application unit 203 acquiring packet data addressed to the print application unit 203 from an external apparatus, the packet analysis unit 205 can also acquire that packet data. Further, packet data addressed to an external apparatus can also be acquired from the print application unit 203 as illustrated by the arrows of the dotted lines in FIG. 2.

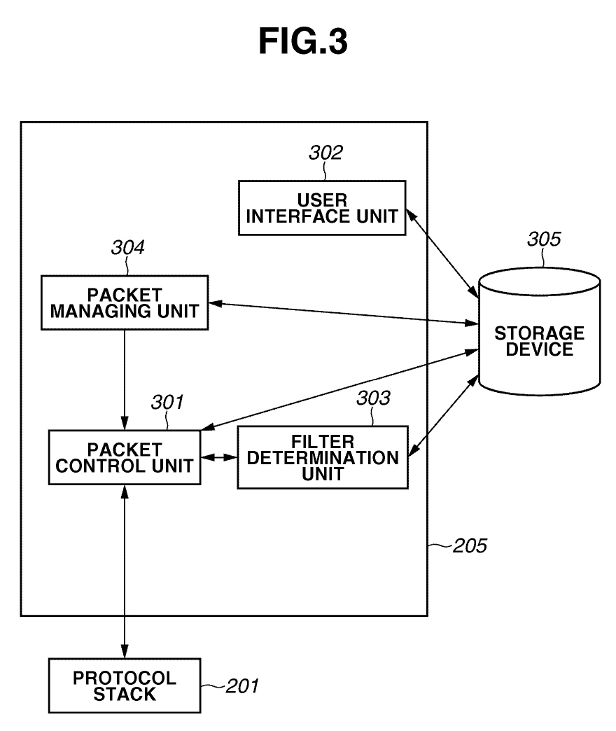

FIG. 3 is a diagram illustrating the software configuration of the packet analysis unit 205 of FIG. 2. The packet analysis unit 205 includes a packet control unit 301, a user interface unit 302, a filter determination unit 303, and a packet managing unit 304. In FIG. 3, the storage device 305 is the NVRAM 105, the HDD 108, etc.

The packet control unit 301 performs the exchange of data with the protocol stack 201. The user interface unit 302 displays, on the operation panel 109, a settings screen which is used by a user to set the condition for filtering packet data (hereinafter, filtering condition) and the packet data acquiring function to ON/OFF. Further, the user interface unit 302 stores the set values which show the contents of what has been set on the settings screen in the storage device 305.

The filter determination unit 303 reads the filter condition set by a user from the storage device 305, and determines whether the packet data corresponds to the filter condition. If packet data is acquired from the protocol stack 201, the packet control unit 301 passes the TCP/IP-related information of that packet data (hereinafter, “TCP/IP information”) to the filter determination unit 303. Based on this TCP/IP information, the filter determination unit 303 determines whether the packet data corresponds to the filter condition, and communicates the determination result to the packet control unit 301. Although the packet control unit 301 temporarily retains all of the packet data acquired from the protocol stack 201 in a cache, packet data which does not correspond to the filter condition is discarded from the cache. On the other hand, packet data which does correspond to the filter condition is stored in the storage device 305.

Examples of filter conditions which can be specified include destination port number, source port number, destination IP address, and source IP address. How a filter condition is set will be described below.

The packet managing unit 304 performs the editing, sending and saving of the packet data stored in the storage device 305. In the case of editing packet data, the packet managing unit 304 reads packet data from the storage device 305, and edits an attribute value of the packet data to an arbitrary value based on the condition set by the user. The packet managing unit 304 can again store the edited packet data in the storage device 305. Further, in the case of sending packet data, the packet managing unit 304 reads packet data from the storage device 305, and sends the packet data via the packet control unit 301.

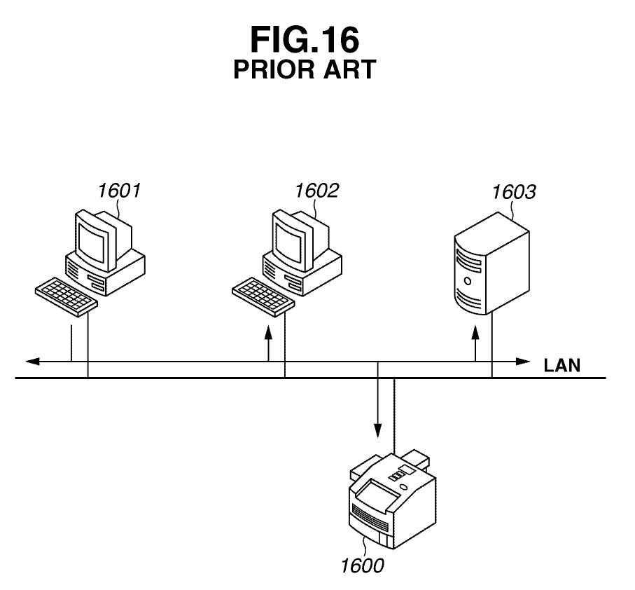

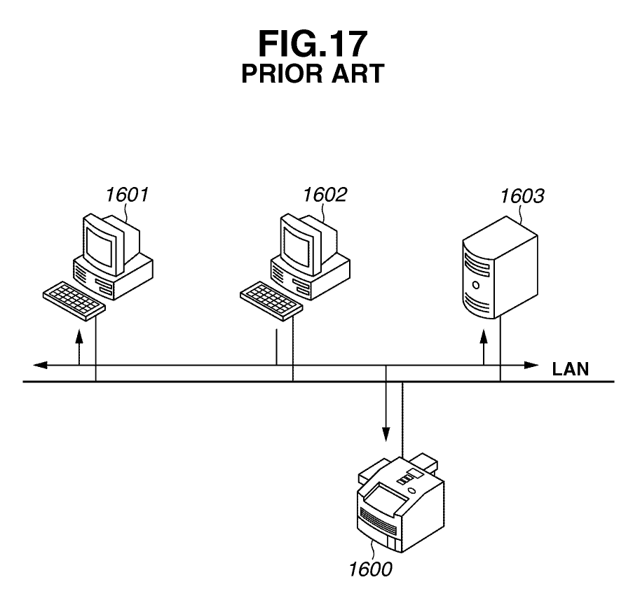

FIGS. 16 and 17 are diagrams illustrating a conventional method for acquiring packet data and a conventional method for reproducing a fault. A client apparatus 1601, a packet acquisition apparatus 1602, a client apparatus 1603, and a print apparatus 1600 are present within the same link. The client apparatus 1601 sends a print request to the print apparatus 1600. The packet acquisition apparatus 1602 executes packet acquisition software capable of acquiring packet data flowing through a LAN, whereby packet data flowing within the link can be acquired.

Although the client apparatus 1603 does not execute packet acquisition software, it temporarily receives packet data from the client apparatus 1601 due to the fact that it is within the same link as the client apparatus 1601. However, after receiving the packet data, based on a determination that the destination IP address of that packet data is not the client apparatus 1603, the client apparatus 1603 discards the packet data.

For example, the client apparatus 1601 sent a print request to the print apparatus 1600, and a network fault has occurred at the print apparatus 1600. In this case, the packet acquisition apparatus 1602 acquires packet data when the fault occurred, and stores such packet data in its own storage device. In order to ascertain the cause of the fault, the user or network administrator analyzes the packet data stored in the storage device of the packet acquisition apparatus 1602.

As illustrated in FIG. 17, when reproducing a fault, the packet acquisition apparatus 1602 resends the packet data stored in its own storage device over a LAN as packet data. However, because the packet acquisition apparatus 1602 randomly acquired the packet data when the fault occurred, along with reproducing the sending of the packet data which was the cause of the fault, other packet data is also reproduced. Further, not only does the print apparatus 1600 receive the print request packet data which is thought to be related to the fault, but the client apparatus 1601 and the client apparatus 1603 again receive unnecessary packet data. As a result, there is the possibility of an unnecessary CPU load being produced, and unnecessary traffic being produced on the LAN.

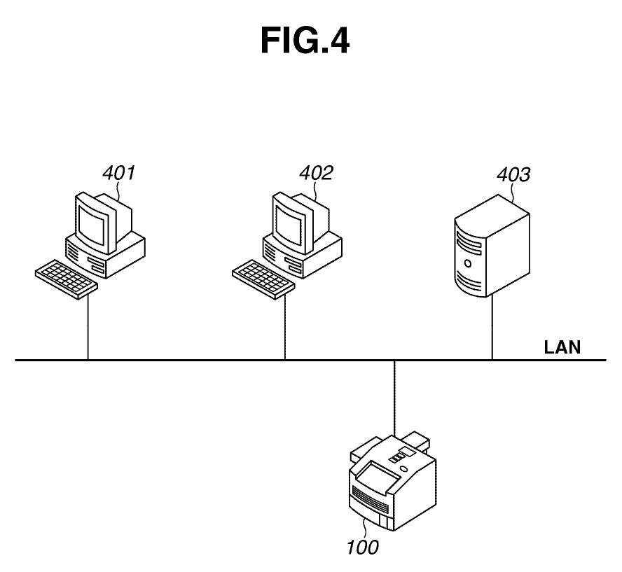

FIG. 4 is a diagram illustrating the network system according to an exemplary embodiment of the present invention. A client apparatus 401, a client apparatus 402, a client apparatus 403, and a communication apparatus 100 are present within the same link. The client apparatus 401 and the client apparatus 402 send a print request or print data to the communication apparatus 100.

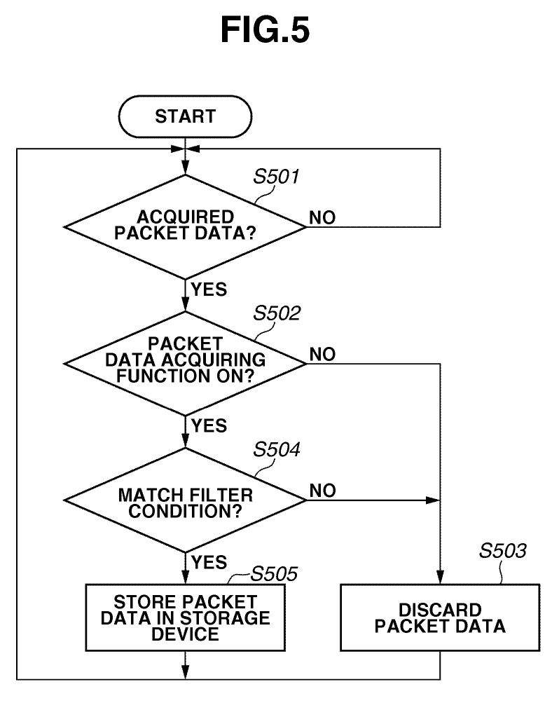

FIG. 5 is a flowchart illustrating the data processing performed by the packet analysis unit 205. For example, if the client apparatus 401 sends a print request to the communication apparatus 100, the protocol stack 201 receives the packet data relating to that print request from the client apparatus 401. Then, the protocol stack 201 transfers the received print request to the print application unit 203 or 204. The print application unit 203 or 204 executes the print processing based on the received print request, and sends a response to the client apparatus 401. On the other hand, since the packet analysis unit 205 is operating in promiscuous mode, it acquires the packet data relating to that print request from the protocol stack 201.

In FIG. 5, in step S501, the packet control unit 301 determines whether packet data has been received from the protocol stack 201. If it is determined that packet data has been received (YES in step S501), in step S502, the packet control unit 301 determines whether the packet data acquisition function is set to “ON” based on the set value stored in the storage device 305. The user uses the user interface unit 302 to pre-set the packet data acquisition function to “ON” or “OFF” at the settings screen displayed on the operation panel 109.

If the packet data acquisition function is set to OFF (NO in step S502), in step S503 the packet control unit 301 discards the acquired packet data.

If the packet data acquisition function is set to ON (YES in step S502), the packet control unit 301 passes the packet data TCP/IP information to the filter determination unit 303. Then, the processing proceeds to step S504. In step S504, the filter determination unit 303 determines whether the packet data matches the filter condition by comparing the TCP/IP information with the filter condition. How the filter condition is set will be described below.

If the packet data does not match the filter condition (NO in step S504), in step S503 the packet control unit 301 discards the acquired packet data based on that determination result.

If the packet data does match the filter condition (YES in step S504), in step S505, the packet control unit 301 stores the acquired packet data in the storage device 305 based on that determination result.

Even if the print application unit 203 or 204 sends packet data to an external apparatus via the protocol stack 201, the packet analysis unit 205 acquires the packet data from the protocol stack 201 and executes processing based on FIG. 5.

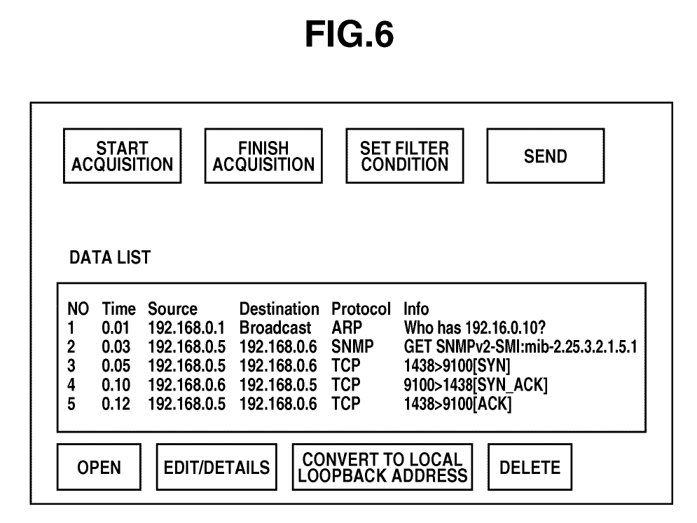

FIG. 6 is a diagram illustrating one example of a list of packet data stored in the storage device 305. The user interface unit 302 displays, on the operation panel 109, a list such as that illustrated in FIG. 6 based on the packet data stored in the storage device 305. When packet data is stored in the storage device 305, the data is stored in a binary format or a compressed binary format. However, when displaying the contents of the packet data on the operation panel 109, the packet data is displayed in a format which can be read by humans.

In FIG. 6, “No.” denotes the number identifying the packet data. “Time” denotes the elapsed time from when the data was acquired. “Source” denotes the source IP address of the packet data, and “Destination” denotes the destination IP address of the packet data. “Protocol” denotes the packet data protocol, and “Info” denotes additional information added to the packet data.

In FIG. 6, the No. 2 packet data is SNMP packet data sent to the communication apparatus 100 from a client apparatus, which is packet data for determining the acquisition of an attribute of the communication apparatus 100. No. 3 packet data is packet data relating to a print request that was sent to the communication apparatus 100 from a client apparatus.

When a user wishes to confirm the details of a given packet data, the user may select that packet data from the list, and pushes the “Edit/Details” button. Then, the user interface unit 302 displays on the operation panel 109 the details screen which shows the details of the packet data based on the packet data stored in the storage device 305.

If the user pushes the “Start Acquisition” button, the packet data acquisition function is set to “ON”, and if the user pushes the “Finish Acquisition” button, the packet data acquisition function is set to “OFF”.

If a user wishes to send a desired packet data to the network, the user may select that packet data from the packet data list, and push the “Send” button. When a user wishes to edit the data of a desired packet data, he/she may select that packet data from the list of packet data, and push the “Edit/Details” button. Then, the user may edit the packet data in the details screen of the packet data. When the user wishes to delete a particular packet data from the storage device 305, he/she may select that packet data from the list of packet data, and push the “Delete” button. The “Filter Condition Setting” button will be described below.

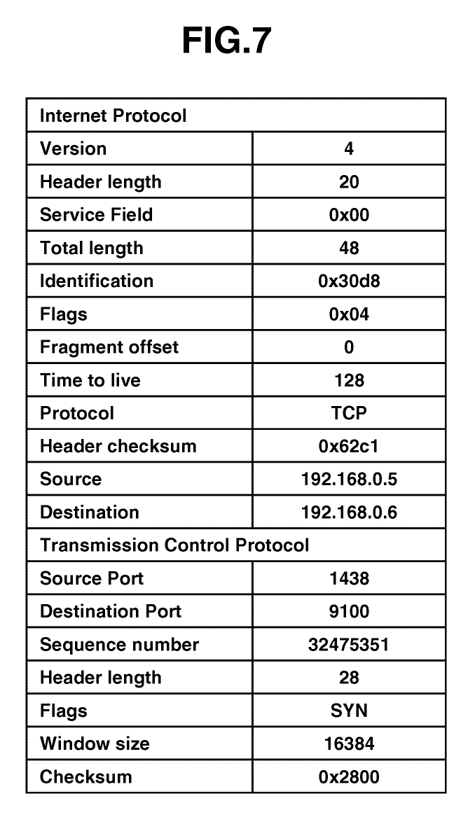

FIG. 7 is a diagram illustrating one example of a details screen which illustrates the details of a packet. FIG. 7 illustrates some information excerpted from the No. 3 packet data. FIG. 7 displays information relating to the IP (Internet Protocol) header and information relating to the TCP (Transmission Control Protocol) header.

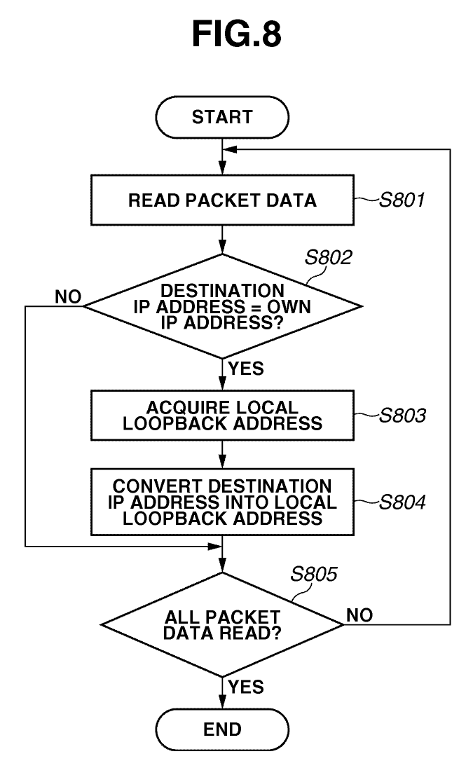

FIG. 8 is a flowchart illustrating the processing performed by the packet analysis unit 205. In the processing based on FIG. 8, the destination IP address addressed to the communication apparatus 100 in the packet data stored in the storage device 305 is converted into a local loopback address.

If the user selects the desired packet data and pushes the “Local Loopback Address” button on a screen like that illustrated in FIG. 6, the processing based on FIG. 8 is executed. The packet data selected by the user may be a single packet data or a plurality of packet data.

It will now be assumed, for example, that a fault occurred when the communication apparatus 100 received the No. 2 packet data of the screen illustrated in FIG. 6. In such a case, the fault can be reproduced by resending No. 2 packet data. Thus, the user selects the No. 2 packet data to convert the destination IP address of the No. 2 packet data into a local loopback address. Likewise, if a fault occurs while the communication apparatus 100 is receiving the packet data of Nos. 1 to 5, the user may select the packet data of Nos. 1 to 5.

In FIG. 8, in step S801, the packet managing unit 304 reads from the storage device 305 one piece of data from among the one or more packet data selected by the user. Next, in step S802, the packet managing unit 304 determines whether the destination IP address of the read packet data matches the IP address of the communication apparatus 100. Thus, packet data whose destination IP address is the same as the IP address of the communication apparatus 100 is searched. Since the IP address of the communication apparatus 100 is stored in the NVRAM 105, the packet managing unit 304 acquires the IP address of the communication apparatus 100 from the NVRAM 105. The IP address of the communication apparatus 100 corresponds to “Destination” in FIG. 7.

If the destination IP address does not match the IP address of the communication apparatus 100 (NO in step S802), the processing proceeds to the below-described step S805.

If the destination IP address does match the IP address of the communication apparatus 100 (YES in step S802), in step S803, the packet managing unit 304 acquires the local loopback address in the communication apparatus 100 from the NVRAM 105. The local loopback address is a special address defining itself. For IPv4, it is defined as “127.0.0.1-127.255.255.254”, and for IPv6, defined as “::1”.

Once the local loopback address is acquired, in step S804, the packet managing unit 304 converts the destination IP address of the read packet data into the acquired local loopback address. In addition, the packet managing unit 304 stores the converted packet data in the storage device 305.

Subsequently, in step S805, the packet managing unit 304 determines whether all of the packet data selected by the user have been read from the storage device 305. If all of the packet data have been read from the storage device 305 (YES in step S805), the processing based on FIG. 8 is finished. On the other hand, if not all of the packet data have been read from the storage device 305 (NO in step S805), the processing returns to step S801, and the packet managing unit 304 reads another packet data from the storage device 305.

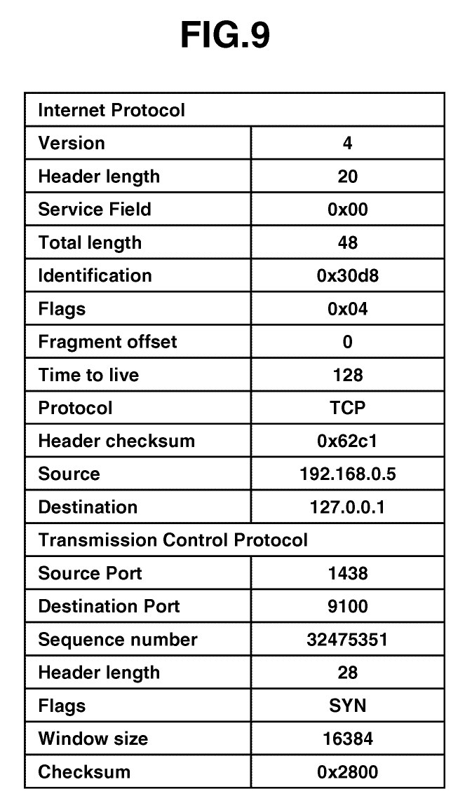

It will now be assumed that the IP address of the communication apparatus 100 is “192.168.0.6”, and that the local loopback addresses of the communication apparatus 100 are “127.0.0.1” and “::1”. Further, it will be assumed that the No. 3 packet data has been selected by the user. If the packet managing unit 304 ascertains the “Version” of the No. 3 packet data, since “Version” is set to 4, the packet managing unit 304 determines that the packet data is IPv4 packet data. Thus, the packet managing unit 304 changes the destination IP address “192.168.0.6” of the No. 3 packet data to “127.0.0.1”. FIG. 9 is a diagram illustrating part of the No. 3 packet data after being changed. Only the destination IP address “Destination” in the IP header is changed to the local loopback address. The other parts are unchanged.

If the packet managing unit 304 ascertains that the “Version” of the packet data is set to 6, the packet managing unit 304 determines that the packet data is IPv6 packet data. Thus, the packet managing unit 304 changes the destination IP address of the packet data to “::1”.

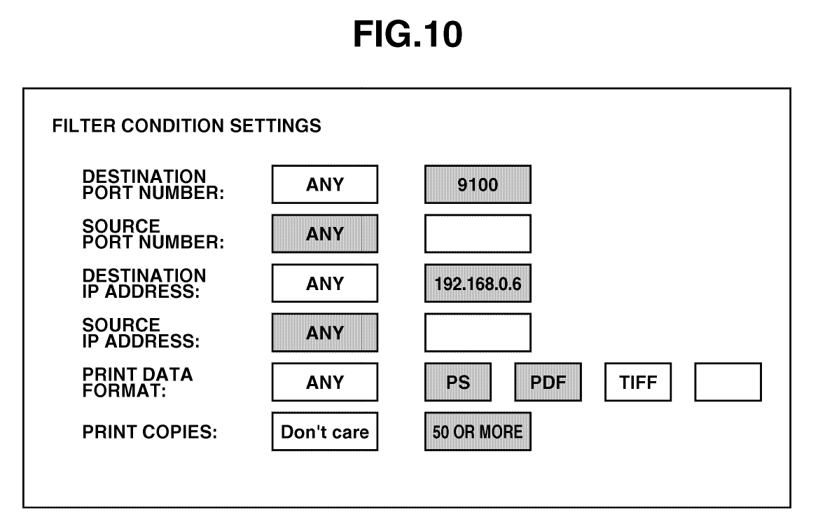

How the filter condition is set will now be described. When a user wishes to set the filter condition, the user pushes the “Set Filter Condition” button on the screen illustrated in FIG. 6. Then, the user interface unit 302 displays on the operation panel 109 a settings screen like that illustrated in FIG. 10. FIG. 10 is a diagram illustrating one example of a settings screen for setting the filter condition.

One example of the filter attributes constituting the filter condition is: “destination port number”, “source port number”, “destination IP address”, “source IP address”, “print data format”, and “print copies”. Each of these filter attributes can be set to “ANY”, which is an arbitrary value. “ANY” denotes that any port numbers, IP addresses, or print data format is accepted.

If a user wishes to set an arbitrary value, the user can set the destination port number to “9100” and the destination IP address to “192.168.0.6”, for example. In the example of FIG. 10, the source port number and the source IP address filter attributes are set to “ANY”, while the other filter attributes are set to specific values.

In the example of FIG. 10, while the destination port number and the destination IP address filter attributes are set to only a specific value, a different IP addresses and port numbers may be specified. Moreover, a range of values may also be specified.

“Print Data Format” and “Print Copies” are filter attributes which have a meaning with respect to the print protocol packet data. “Print Data Format” specifies the format of the print data relating to the packet data which should be filtered. In the example of FIG. 10, packet data relating to PS format print data or PDF format print data is stored in the storage device 305 by the packet control unit 301. On the other hand, packet data relating to TIFF format print data is not stored in the storage device 305 even if it is received in the communication apparatus 100, since such data does not match the filter condition. A user may specify another print data format by specifying a unique extension. “Print Copies” specifies the number of print copies of the print data relating to the packet data which should be filtered. If a user specifies “Don't care”, print copies is ignored. If “50 or more” is specified as shown in FIG. 10, packet data of a print request or print data for 10 copies would not satisfy the filter condition. Likewise, packet data of a print request or print data for 100 copies would not satisfy the filter condition.

The filter attributes may be different to those illustrated in FIG. 10, and filter attributes unique to the communication apparatus 100 may be prepared. Other examples include “number of pages”, “page description”, “paper feed method”, “color”, “black & white”, “application executing printing”, and the like.

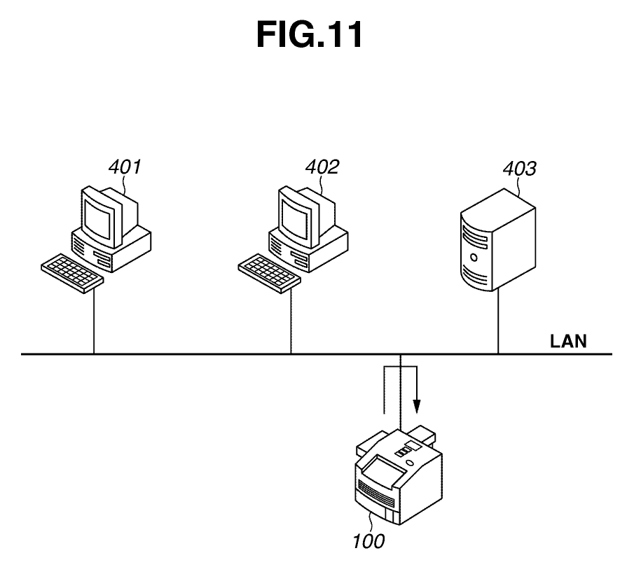

FIG. 11 is a diagram illustrating the state when packet data edited by the processing of FIG. 8 is sent to reproduce a fault. The packet data edited by the processing of FIG. 8 has a local loopback address for its destination IP address. Therefore, after the protocol stack 201 receives the packet data from the packet analysis unit 205, the protocol stack 201 sends the packet data addressed to the local loopback address (self-addressed to the communication apparatus 100). Namely, the packet data is received via a driver interface and is processed as if it was received from the LAN without being sent over the LAN. At this stage, the client apparatus 401, client apparatus 402, and the client apparatus 403, which are within the same link, are not subjected to increase unnecessary network traffic. Therefore, the reproduction of a fault can be realized while suppressing network traffic and the amount of work for the user.

If the No. 3 packet data in FIG. 6, for example, is sent after editing according to the processing of FIG. 8, the sending of the packet data relating to the print request is reproduced. However, the processing of the print processing based on the print request is also reproduced. To avoid unnecessary printing from being performed, some users may only wish to reproduce the sending of the packet data, and do not want to reproduce the print processing based on the print request. In such cases, the below-described discard mode is effective.

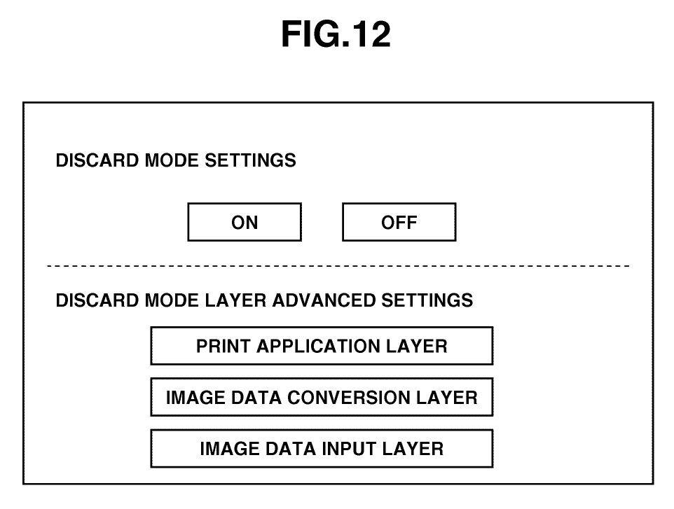

FIG. 12 is a diagram illustrating one example of the settings screen for setting a discard mode. The user interface unit 302 displays on the operation panel 109 a settings screen like that illustrated in FIG. 12. If the discard mode is set to “ON”, the communication apparatus 100 discards at a certain stage the print data or the image data based on that print data even if packet data relating to the print data is received. As a result, printing based on the print data is not performed.

The advanced settings of the discard mode can be set, for example, at the settings screen of FIG. 12. In particular, by allowing the layer in which the print data or image data is discarded to be selected, the reason why an error is occurring can be more easily identified. For example, it is possible to specify an application layer of the print application unit 203 or the like, the layer in which the print data is converted into printable image data by the printer unit 110, or the layer in which the image data is input into the printer unit 110. As a result, the user can more efficiently reproduce and evaluate the fault. The settings value set at the settings screen of FIG. 12 is stored in the NVRAM 105.

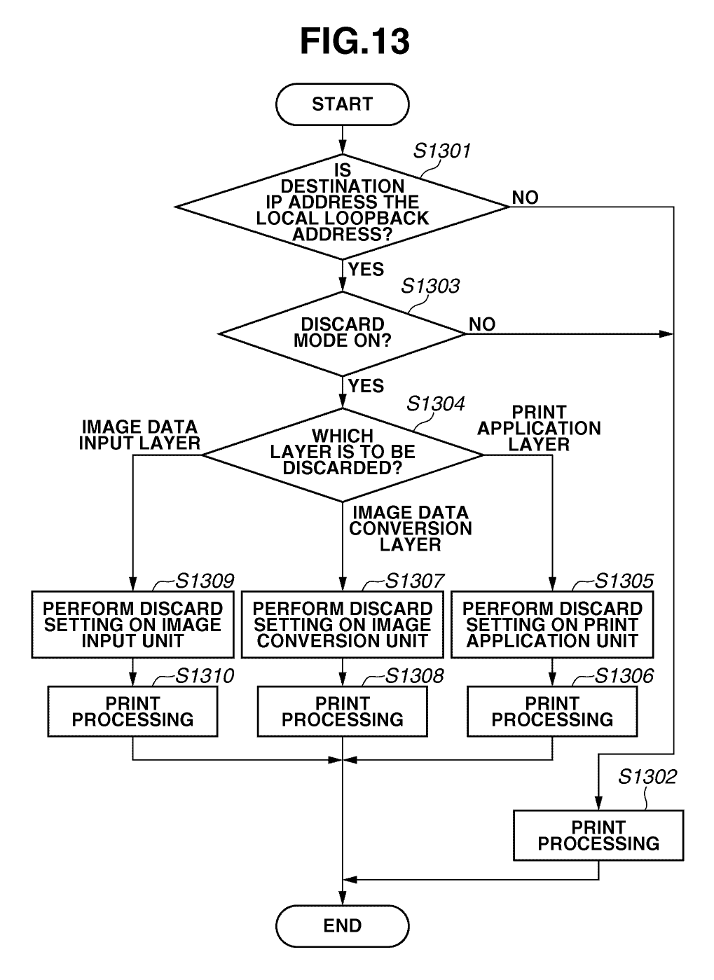

FIG. 13 is a flowchart illustrating the data processing performed by the printing application unit 203 or the printing application unit 204. Here, description will be made using the printing application unit 203 as an example. If the destination port number of the packet data is the port number corresponding to the print application unit 203, the protocol stack 201 passes the received data to the print application unit 203. At this stage, if the destination IP address of the packet data is the local loopback address, the protocol stack 201 notifies the print application unit 203 of that fact.

Once the received data is received from the protocol stack 201, in step S1301, the print application unit 203 determines whether the destination IP address of the received data is the local loopback address. This determination is performed based on notification from the protocol stack 201.

If the destination IP address is not the local loopback address (NO in step S1301), in step S1302 the print application unit 203 performs print processing as normal. In normal print processing, the print application unit 203 analyzes the received data and passes the received data to an image data conversion unit. At the image data conversion unit, the received data is converted into image data in a printable format, and the image data is transferred to an image data input unit. The image data input unit inputs image data into the printer unit 110. The printer unit 110 prints an image based on the image data.

If the destination IP address is the local loopback address (YES in step S1301), in step S1303, the print application unit 203 determines whether the discard mode is set to ON or OFF. This determination is performed by reading the settings value stored in the NVRAM 105, and basing the determination on that settings value.

If the discard mode is set to OFF (NO in step S1303), in step S1302, the print application unit 203 performs print processing as normal. On the other hand, if the discard mode is set to ON (YES in step 1303), in step S1304, the print application unit 203 determines which layer is to be discarded. This determination is performed by reading the settings values stored in the NVRAM 105, and basing the determination on that settings value.

If the layer to be discarded is the print application layer (PRINT APPLICATION LAYER in step S1304), in step S1305, the print application unit 203 performs the discard setting on itself. In addition, in step S1306, the print application unit 203 discards the received data before analyzing the received data and passing on the received data to the image data conversion unit. For example, if in step S1306, a print error occurs, the print application unit 203 infers that the cause of the error lies in the section analyzing the received data.

If the layer to be discarded is the layer which converts the image data (IMAGE DATA CONVERSION LAYER in step S1304), in step S1307, the print application unit 203 transmits the discard order to the image data conversion unit, and performs the discard setting on the image data conversion unit. In addition, in step S1308, the print application unit 203 analyzes the received data and passes the received data on to the image data conversion unit. At the image data conversion unit, the received data is converted into a printable format by the printer unit 110. However, the image data conversion unit discards the image data before transferring the image data to the image data input unit. For example, if in step S1308, a print error occurs, the print application unit 203 infers that the cause of the error lies in the section analyzing the received data or in the image data conversion unit.

If the layer to be discarded is the layer in which image data is input into the printer unit 110 (IMAGE DATA INPUT LAYER in step S1304), in step S1309, the print application unit 203 transmits the discard order to the image data input unit, and performs the discard setting on the image data input unit. In addition, in step S1310, the print application unit 203 analyzes the received data and passes the received data on to the image data conversion unit. At the image data conversion unit, the received data is converted into a printable format by the printer unit 110, and the image data is transferred to the image data input unit. The image data input unit discards the image data before transferring the image data to the printer unit 110. For example, if in step S1310, a print error occurs, the print application unit 203 infers that the cause of the error lies in the section analyzing the received data, in the image data conversion unit, or in the image data input unit.

Further, if a print error only occurs in step S1302, it is inferred that the cause of the error lies in the printer unit 110, meaning that the cause of the error can be narrowed down to a hardware problem.

Further, even if the image data conversion unit or the image data input unit is a part of the print application unit 203, these units may be different software or hardware from the print application unit 203.

Thus, by providing a discard mode, not only can unnecessary printing be reduced, but the possible location of the cause of an error can be narrowed down.

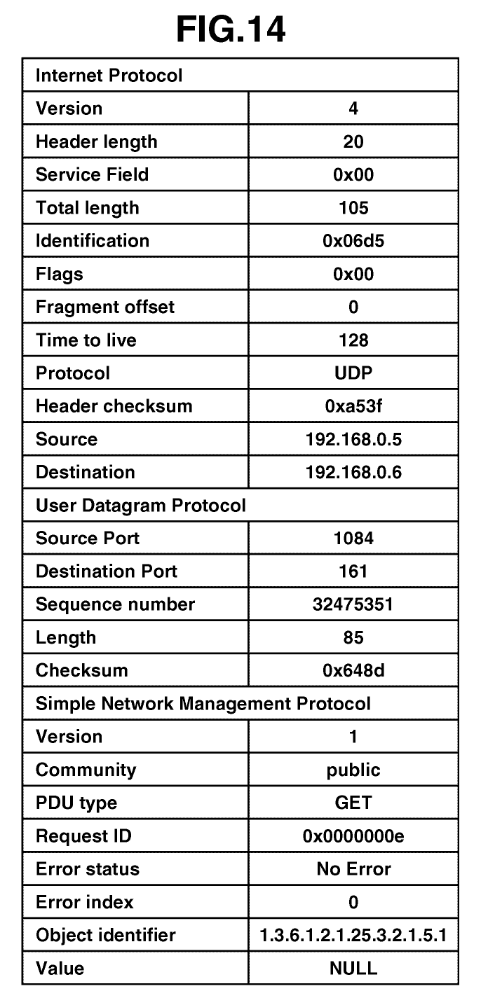

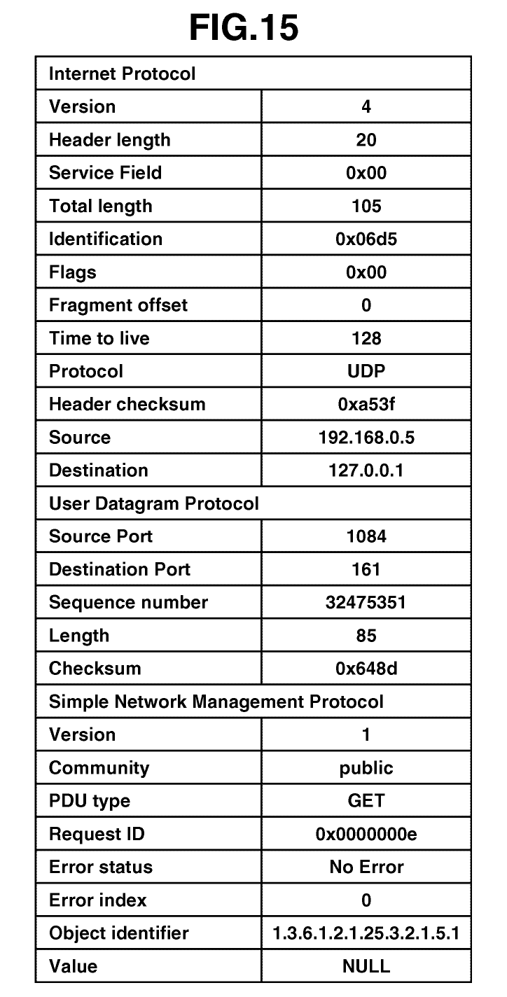

Below, an example other than packet data relating to the print request will be described. FIG. 14 is a diagram illustrating part of the No. 2 packet data of FIG. 6. The No. 2 packet data is packet data relating to SNMP. FIG. 15 is a diagram illustrating the No. 2 packet data after being subjected to processing based on FIG. 8. In FIG. 15, the destination IP address (“Destination”) is the local loopback address “127.0.0.1”.

In the above description, the address of the packet data is explained as an IP address. However, the address is not limited to an IP address, and may be derived from some other protocol having an address indicating itself.

The present invention can also be achieved by directly or remotely supplying to a system or an apparatus a software program for realizing the function of the above-described exemplary embodiment, and having a computer of that system or apparatus read and execute the supplied program. In this case, the mode does not have to be a program, so long as it has the function of a program.

Therefore, to realize the functional processing of the present invention with a computer, the program code itself which is to be installed in the computer also realizes the present invention. Namely, the computer program for realizing the functional processing of the present invention is itself also included in the present invention. In this case, the mode of the program is not limited so long as it has the function of a program, and may be an object code, a program executed by an interpreter, script data supplied to the OS, and the like.

Various recording media can be used for supplying the program. Examples thereof include a floppy disk, a hard disk, an optical disk, a magneto optical disk (MO), a compact disc recordable (CD-R), a CD-rewritable (CD-RW), a magnetic tape, a non-volatile memory card, a ROM, a digital versatile disk (DVD) (DVD-ROM, DVD-R), and the like.

In addition, an example of a method for supplying the program is to use the browser of a client computer to connect to an Internet homepage, and download from the homepage onto a recording medium such as a hard disk and the like. In such a case, what is downloaded may be the computer program itself according to the exemplary embodiments of the present invention, or a compressed file containing an automatic installation function.

Further, the present invention can also be realized by dividing the program code constituting the program according to the exemplary embodiments of the present invention into a plurality of files, and downloading each of those files from different homepages. Namely, a WWW server which allows a plurality of users to download the program files for realizing the functional processing according to the exemplary embodiments of the present invention by a computer is also included in the present invention.

Further, the present invention may be a mode wherein the program according to the exemplary embodiment of the present invention is encrypted, stored on a recording medium such as a CD-ROM, and distributed to a user. In such a case, a user satisfying certain conditions is allowed to download key information for unlocking the encryption from a homepage via the Internet, so that by using that key information the encrypted program is installed on a computer in an executable format.

Further, the present invention can also be realized in a mode other than those in which the function of the above-described exemplary embodiment is realized, by having a computer execute a read program. For example, based on an instruction from that program, the OS or the like running on the computer performs part or all of the actual processing, and from that processing the function of the above-described exemplary embodiment can be realized.

In addition, the present invention may be configured so that a program read from a recording medium is read into a memory which is provided on a function expansion board inserted into the computer or a function expansion unit connected to the computer. In such a case, subsequently, based on an instruction from the program, a CPU (or the like) provided on the function expansion board or function expansion unit performs part or all of the actual processing. As such, the processing of the function of the above-described exemplary embodiment is realized.

While the present invention has been described with reference to the exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-161430 filed Jun. 19, 2007, which is hereby incorporated by reference herein in its entirety.

What is claimed is:

1. A communication apparatus comprising:
a receiving unit configured to receive data including a destination address from an external apparatus;
a change unit configured to change the destination address to an address of the communication apparatus; and
a sending unit configured to send the data whose destination address was changed, to the address of the communication apparatus.

2. The communication apparatus according to claim 1, wherein the data is packet data that includes the destination address as a header.

3. The communication apparatus according to claim 1, further comprising a search unit configured to search for data, whose destination address indicates the communication apparatus from data received by the receiving unit,
wherein the change unit is configured to change the destination address included in the data searched for by the search unit to an address indicating the communication apparatus.

4. The communication apparatus according to claim 1, further comprising:
a setting unit configured to set a condition for identifying specific packet data;
a comparison unit configured to compare the data received by the receiving unit with the condition set by the setting unit; and
a storage unit configured to store the data matching the condition set by the setting unit according to a comparison result of the comparison unit,
wherein the change unit is configured to change the destination address included in the data stored in the storage unit to an address of the communication apparatus.

5. The communication apparatus according to claim 4, wherein the condition set by the setting unit includes at least one of a condition relating to information contained in an IP header, a condition relating to information contained in a TCP header, and a condition relating to printing.

6. The communication apparatus according to claim 1, wherein, if the data received by the receiving unit is IPv4 data, the change unit changes the destination address contained in the data to a local loopback address of IPv4, and if the data received by the receiving unit is IPv6 data, the change unit changes the destination address contained in the data to a local loopback address of IPv6.

7. The communication apparatus according to claim 1, further comprising:
a second receiving unit configured to receive data including an address of the communication apparatus as the destination address; and
a discard unit configured to discard the received data from the second receiving unit.

8. The communication apparatus according to claim 1, wherein the address of the communication apparatus is a local loopback address.

9. A method for data processing, the method comprising:
receiving data including a destination address from an external apparatus;
changing the destination address to an address of the communication apparatus; and
sending the data whose destination address was changed to the address of the communication apparatus.

10. A computer-readable recording medium for storing a program which executes a method for data processing, the method comprising:
receiving data including a destination address from an external apparatus;
changing the destination address to an address of the communication apparatus; and
sending the data whose destination address was changed to the address of the communication apparatus.
